(19) United States
(12) Patent Application Publication
(10) Pub. No.: US 2016/0140736 A1
(43) Pub. Date: May 19, 2016

(54) VIEWPOINT POSITION CALCULATION DEVICE, IMAGE GENERATION DEVICE, AND VIEWPOINT POSITION CALCULATION METHOD

(71) Applicant: KABUSHIKI KAISHA TOSHIBA, Tokyo (JP)

(72) Inventors: Norihiro NAKAMURA, Kawasaki (JP); Akihito SEKI, Yokohama (JP); Masaki YAMAZAKI, Tokyo (JP); Takaaki KURATATE, Kawasaki (JP); Ryo NAKASHIMA, Kawasaki (JP)

(21) Appl. No.: 14/944,576

(22) Filed: Nov. 18, 2015

(30) Foreign Application Priority Data
Nov. 18, 2014 (JP) 2014-233783

(51) Int. Cl. G06T 7/60; G06T 7/00

(52) U.S. Cl. CPC G06T 7/60; G06T 7/0081; G06T 2207/10012

(57) ABSTRACT

According to one embodiment, a viewpoint position calculation device includes a shape acquisitor, a measurement information acquisitor, and a viewpoint position calculator. The shape acquisitor is configured to acquire a shape data representing a three-dimensional shape of an object including first and second positions. The measurement information acquisitor is configured to acquire a first measurement information data including line segment data related to a line segment connecting the first position with the second position. The viewpoint position calculator is configured to calculate a viewpoint based on the shape data and the first measurement information data. A first image of the object as viewed from the viewpoint is generated based on the shape data and the line segment data. The first image includes an image of a first region of the object and an image of the line segment. The first region includes the first position and the second position.

### CROSS-REFERENCE TO RELATED APPLICATIONS

This application is based upon and claims the benefit of priority from Japanese Patent Application No. 2014-233783, filed on Nov. 18, 2014; the entire contents of which are incorporated herein by reference.

### FIELD

Embodiments described herein relate generally to a viewpoint position calculation device, an image generation device, and a viewpoint position calculation method.

### BACKGROUND

An image can be generated using data obtained by measuring the three-dimensional shape of an object. The shape of the object can be confirmed from various directions by changing the viewpoint for generating the image. It is desired to provide an easily viewable image of this kind.

### BRIEF DESCRIPTION OF THE DRAWINGS

FIG. 1 is a block diagram illustrating a viewpoint position calculation device and an image generation device according to a first embodiment;

FIG. 2 is a flow chart illustrating viewpoint position calculation and image generation according to the first embodiment;

FIG. 3A to FIG. 3C are schematic views illustrating the situation of dimension measurement;

FIG. 4 is a schematic view illustrating part of the shape data, and the measurement information data;

FIG. 5 is a flow chart illustrating the derivation of a measurement target face group according to the first embodiment;

FIG. 6 is a schematic view illustrating the derivation of a measurement target face group according to the first embodiment;

FIG. 7 is a schematic view illustrating a measurement target face group according to the first embodiment;

FIG. 8 is a schematic view illustrating the calculation of a candidate viewpoint position according to the first embodiment;

FIG. 9 is a schematic view illustrating the calculation of the candidate viewpoint position according to the first embodiment;

FIG. 10A and FIG. 10B are schematic views illustrating an evaluation shape according to the first embodiment;

FIG. 11A to FIG. 11C are schematic views illustrating the operation of an image generation device;

FIG. 12 is a block diagram illustrating a viewpoint position calculation device and an image generation device according to a second embodiment;

FIG. 13 is a flow chart illustrating viewpoint position calculation and image generation according to the second embodiment;

FIG. 14 is a block diagram illustrating a viewpoint position calculation device and an image generation device according to a third embodiment;

FIG. 15 is a flow chart illustrating viewpoint position calculation and image generation according to the third embodiment; and

FIG. 16A and FIG. 16B are schematic views illustrating the operation of the viewpoint position calculation device and the image generation device according to the third embodiment.

### DETAILED DESCRIPTION

According to one embodiment, a viewpoint position calculation device includes a shape acquisitor, a measurement information acquisitor, and a viewpoint position calculator. The shape acquisitor is configured to acquire a shape data representing a three-dimensional shape of an object including a first portion and a second portion. The shape data includes information on a first position of the first portion and a second position of the second portion. The measurement information acquisitor is configured to acquire a first measurement information data including line segment data related to a line segment connecting the first position with the second position. The line segment corresponds to a length subjected to measurement. The viewpoint position calculator is configured to calculate a viewpoint based on the shape data and the first measurement information data. A first image of the object as viewed from the viewpoint is generated based on the shape data and the line segment data. The first image includes an image of a first region of the object and an image of the line segment. The first region includes the first position and the second position.

According to another embodiment, an image generation device includes a shape acquisitor, a measurement information acquisitor, and a display image generator. The shape acquisitor is configured to acquire a shape data representing a three-dimensional shape of an object including a first portion and a second portion, the shape data including information on a first position of the first portion and a second position of the second portion. The measurement information acquisitor is configured to acquire a first measurement information data including a line segment data related to a line segment connecting the first position with the second position. The line segment corresponds to a length subjected to measurement. A display image generator is configured to generate a first image based on the shape data and the first measurement information data. The first image includes an image of a first region of the object and an image of the line segment. The first region includes the first position and the second position.

According to another embodiment, a viewpoint position calculation method includes acquiring a shape data representing a three-dimensional shape of an object including a first portion and a second portion. The shape data includes information on a first position of the first portion and a second position of the second portion. The method includes acquiring a first measurement information data including a line segment data related to a line segment connecting the first position with the second position. The line segment corresponds to a length subjected to measurement. The method includes calculating a viewpoint based on the shape data and the first measurement information data. A first image of the object as viewed from the viewpoint is generated from the shape data and the line segment data. The first image includes an image of a first region of the object and an image of the line segment. The first region includes the first position and the second position.

Various embodiments will be described hereinafter with reference to the accompanying drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In this specification and the drawings, components similar to those described previously with reference to earlier figures are labeled with like reference numerals, and the detailed description thereof is omitted appropriately.

### First Embodiment

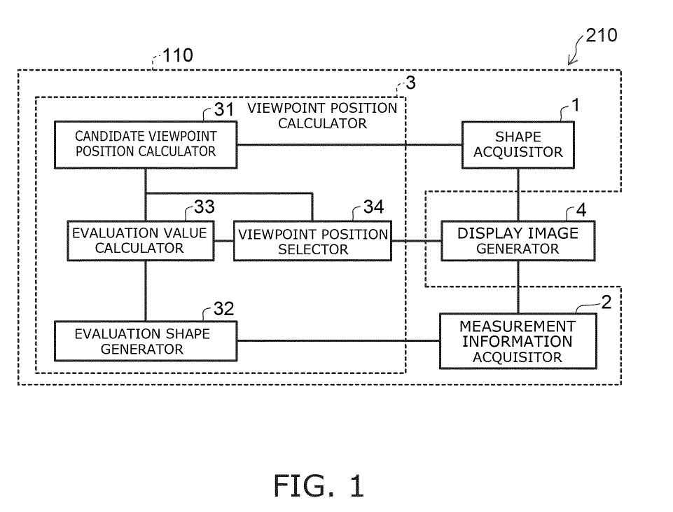

FIG. 1 is a block diagram illustrating a viewpoint position calculation device and an image generation device according to a first embodiment.

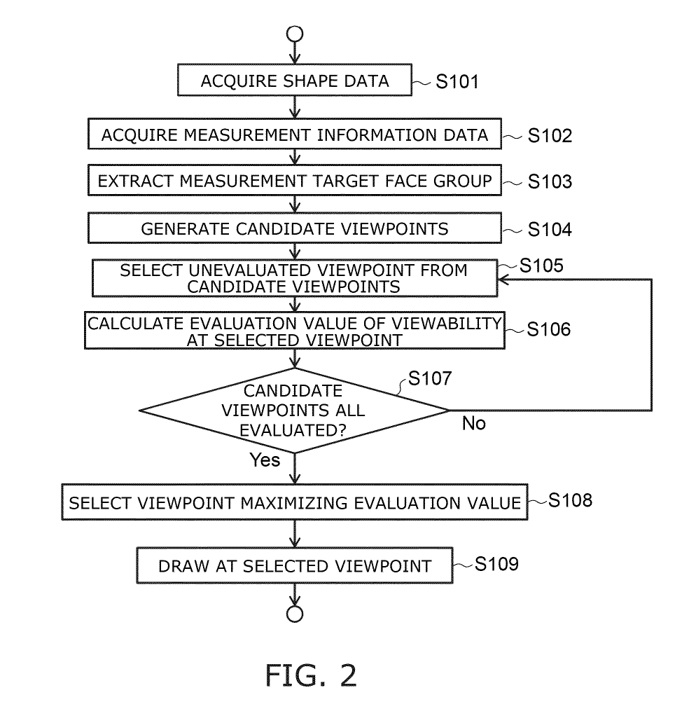

FIG. 2 is a flow chart illustrating viewpoint position calculation and image generation according to the first embodiment.

As shown in FIG. 1, the image generation device 210 according to this embodiment includes a viewpoint position calculation device 110 and a display image generator 4.

The viewpoint position calculation device 110 includes a shape acquisitor 1, a measurement information acquisitor 2, and a viewpoint position calculator 3.

The viewpoint position calculator 3 includes a candidate viewpoint position calculator 31, an evaluation shape generator 32, an evaluation value calculator 33, and a viewpoint position selector 34.

For instance, each block included in the image generation device 210 and the viewpoint position calculation device 110 is based on a computation device including e.g. CPU (central processing unit) and memory. The shape acquisitor 1 and the measurement information acquisitor 2 may include an input/output interface for external communication in a wireline or wireless manner. Part or all of each block can be based on an integrated circuit such as LSI (large scale integration), or an IC (integrated circuit) chip set. Each block may be based on a separate circuit. Alternatively, part or all of the blocks may be integrated into a circuit. The blocks may be integrated with each other, or part of the blocks may be provided separately. Part of each block may be provided separately. The integration is not limited to LSI, but may be based on a dedicated circuit or general-purpose processor.

The blocks of FIG. 1 may be configured to enable direct or indirect communication with each other through a communication network. The communication network is e.g. LAN (local area network) or a network such as the Internet (cloud).

The shape acquisitor 1 acquires shape data (step S101). Here, the shape data is data representing the three-dimensional shape of an object. The object is e.g. the inner wall of an elevator hoistway, the rail attached to control the traveling direction of an elevator cage, and a bracket attached to the wall surface to support the rail. However, in the embodiment, the object is not limited to this example. In the shape data, the shape of the object is represented by e.g. a set of triangular faces. The viewpoint position calculation device 110 and the image generation device 210 according to the embodiment are used for dimension measurement of each portion of the object represented by the shape data.

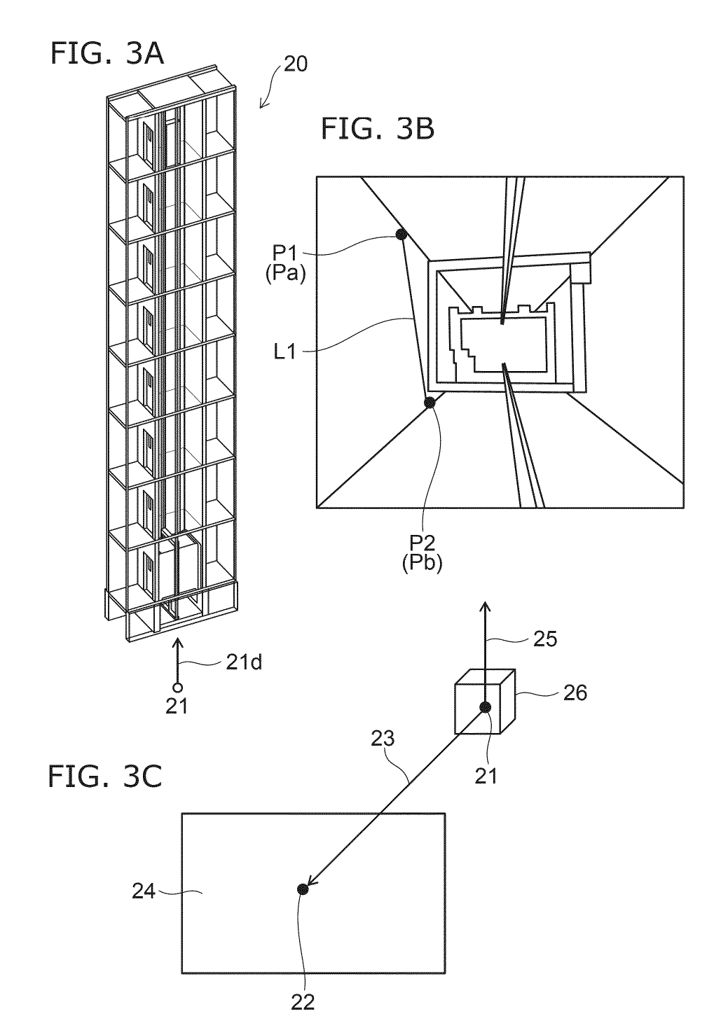

FIG. 3A to FIG. 3C are schematic views illustrating the situation of dimension measurement. FIG. 3A illustrates an object represented by the shape data. In this example, the object is an elevator shaft 20.

FIG. 3B illustrates an image generated from the shape data. The image shown in FIG. 3B is an image obtained by rendering the shape data of FIG. 3A. In this example, the viewpoint 21 used for rendering is located below the elevator (bottom of the page). The image of FIG. 3B corresponds to an image of the elevator shaft 20 viewed upward from the viewpoint 21 along the viewpoint direction 21d.

Points for the base of measurement (measurement base points) are specified on the surface of the object represented by the shape data. More specifically, two points on the image are selected in accordance with the site to be measured on the shape data. For instance, a first measurement base point (first position P1) and a second measurement base point (second position P2) are selected. Then, the dimension can be measured by calculating the distance therebetween. At this time, a line segment L1 is defined so that the two measurement base points are its endpoints. The line segment L1 is displayed on e.g. a display. This can clarify the dimension measured by the specified measurement base points. In the case where dimension measurement is performed a plurality of times, this can clarify the combination of measurement base points.

The measurement information acquisitor 2 acquires measurement information data (step S102). The measurement information data is data related to a combination of measurement base points, the ID of a face corresponding to each measurement base point, and a line segment.

The viewpoint position calculator 3 calculates a viewpoint based on the shape data and the measurement information data. The object (rail, bracket, wall surface, or ceiling) with the measurement base points defined thereon, the measurement base points, and the line segment are viewable from the viewpoint (steps S103-S108).

The display image generator 4 generates a display image (first image) of the object as viewed from the viewpoint by rendering the shape data and the measurement information data (line segment data) using the viewpoint calculated by the viewpoint position calculator 3 (step S109). The display image includes an image of a first region of the object including the first position P1 and the second position P2. Furthermore, the display image includes an image of the line segment L1.

For instance, as shown in FIG. 3C, the display image generator 4 projects the shape data and the line segment data on a plane 24 (screen surface). The plane 24 is a plane such that the vector 23 formed from the viewpoint 21 and the point-of-regard 22 is its normal vector. The rendering method is not limited to the above method, but may be based on various rendering techniques commonly used in the field of computer graphics (CG). For instance, in the field of CG, the Look-at vector and the Up vector are used to control a camera 26. The vector 23 formed from the viewpoint 21 and the point-of-regard 22, and an orientation vector 25 correspond to the Look-at vector and the Up vector, respectively. Various rendering methods that can be processed using these vectors are applicable.

The details of the blocks shown in FIG. 1 are described below.

(1) Shape Acquisitor 1

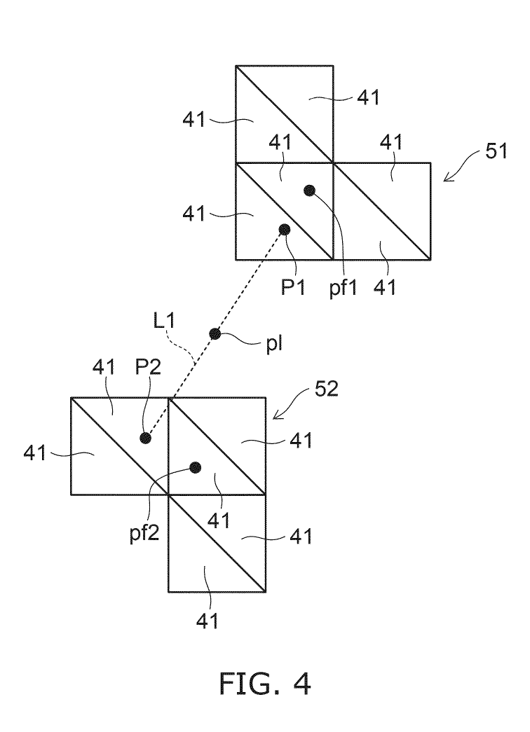

The shape acquisitor 1 acquires shape data representing an elevator shaft from an external storage or a three-dimensional distance measurement device (step S101). FIG. 4 is a schematic view illustrating part of the shape data, and the measurement information data. As shown in FIG. 4, the shape data is represented by a set of triangular faces 41. A unique face ID is defined for each triangular face 41. A polygonal face having four or more vertices, and a parametrically represented shape such as a curved surface, can be converted to a representation based on triangular faces.

The external storage is not limited to a storage medium such as a hard disk and CD, but includes a server connected by a communication network.

The three-dimensional distance measurement device can be e.g. a laser range finder or a stereo camera. The stereo camera can obtain a three-dimensional point by estimating the depth of each pixel based on the image. The data obtained from such devices is a three-dimensional point. Thus, a triangular face is constructed from the obtained point group. This can be based on various methods such as the method of constructing a face using the detector of the laser range finder or the adjacency relation of pixels, and the method of directly estimating a face from the point group.

(2) Measurement Information Acquisitor 2

The measurement information acquisitor 2 acquires measurement information data. In this example, the measurement information data refers to a combination of two measurement base points, one line segment, and the face ID of a triangular face including each measurement base point (step S102).

For instance, the object includes a first portion Pa located at a first position P1, and a second portion Pb located at a second position P2. The shape data includes information on the first position P1 and the second position P2 of the object. A line segment L1 connecting the first position P1 with the second position P2 is defined in the case of measuring the distance between the first position P1 and the second position P2. That is, the line segment L1 is a line segment corresponding to the length subjected to dimension measurement. In other words, the first position P1 is the start position of the measurement. The second position P2 is the end position of the measurement. The line segment L1 is a line segment extending from the first position P1 to the second position P2.

For instance, one measurement information data (first measurement information data) includes one line segment data. In the example of FIG. 4, the line segment data includes information on the first position P1, the second position P2, and the line segment L1. In the embodiment, a plurality of measurement information data (line segment data) can be defined corresponding to the sites to be measured.

(3) Viewpoint Position Calculator 3

(3-1) Candidate Viewpoint Position Calculator 31

The candidate viewpoint position calculator 31 calculates a plurality of candidate viewpoints based on the shape data and the measurement information data. The candidate viewpoint is a candidate of the viewpoint to be finally used. The viewpoint finally used in the display image generator 4 is one selected from the plurality of candidate viewpoints calculated here.

In calculating a candidate viewpoint, the candidate viewpoint position calculator 31 calculates a viewpoint position, a point-of-regard position, and an orientation vector determining the direction directly above the viewpoint position. These are used in calculating a viewpoint. The candidate viewpoint position calculator 31 performs processing corresponding to step S103 and step S104 in the flow chart.

(Step S103)

The candidate viewpoint position calculator 31 determines a measurement target face group with reference to the triangular face including the measurement base point. The measurement target face group refers to a set of face IDs of triangular faces located near the triangular face including the measurement base point. A plurality of triangular faces belonging to one measurement target face group can be regarded as substantially forming one plane.

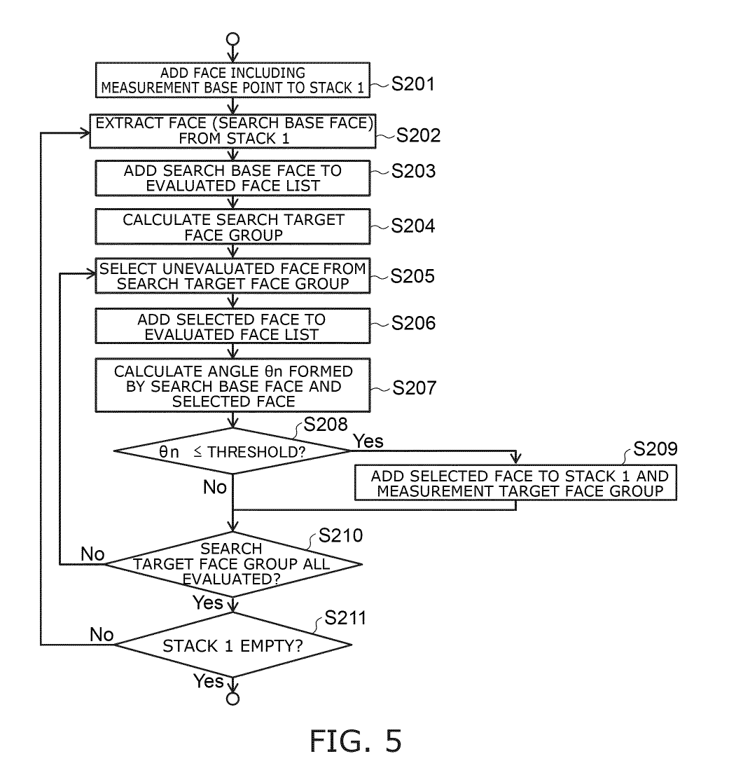

FIG. 5 is a flow chart illustrating the derivation of a measurement target face group according to the first embodiment.

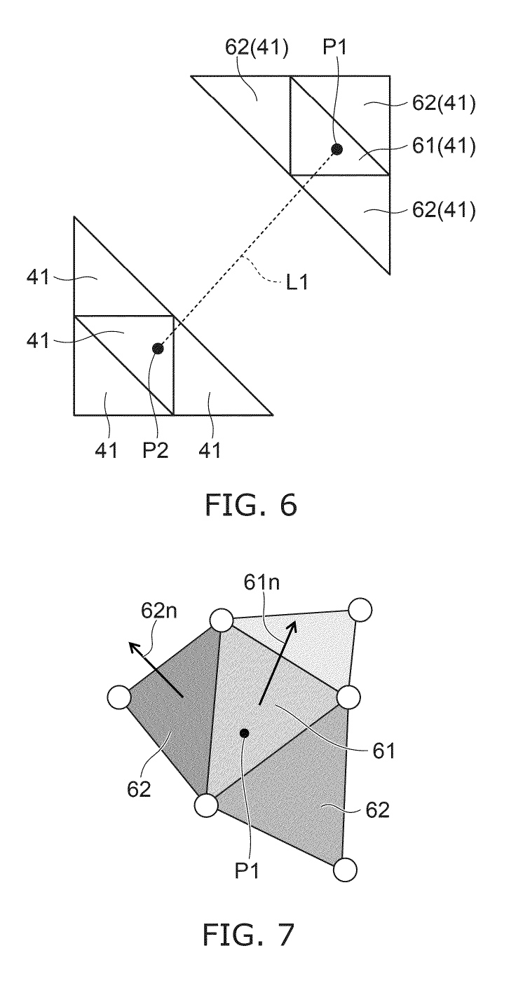

FIG. 6 is a schematic view illustrating the derivation of a measurement target face group according to the first embodiment.

FIG. 7 is a schematic view illustrating a measurement target face group according to the first embodiment.

As shown in FIG. 5, first, in step S201, the face ID of the triangular face including the measurement base point is added to stack 1. For instance, a plurality of face IDs are added to stack 1. Each of the triangular faces corresponding to the plurality of face IDs includes one of the measurement base points.

In step S202, one of the face IDs is extracted from stack 1. In step S203, the extracted face ID is added to an evaluated face list.

In the example of FIG. 6, the triangular face (search base face 61) corresponding to the extracted face ID includes e.g. a first measurement base point (first position P1).

In step S204, a triangular face (search target face 62) is calculated. The search target face 62 shares an edge with (is adjacent to) the search base face 61. Furthermore, the face ID of the search target face 62 has not been registered in the evaluated face list. Thus, a search target face group including a plurality of search target faces 62 is calculated.

In step S205, one unevaluated search target face 62 is selected from the search target face group. In step S206, the selected search target face 62 is added to the evaluated face list. In step S207, the angle θn formed by the normal vector 62n of the selected search target face 62 and the normal vector 61n of the search base face 61 is calculated (see FIG. 7).

In step S208, it is determined whether the magnitude of the angle θn is less than or equal to a prespecified threshold. If the magnitude of the angle θn is less than or equal to the threshold, it is regarded that the two faces are directed in the same direction. That is, it is regarded that the selected search target face 62 and the search base face 61 are located on the same plane. Then, proceeding to step S209, the face ID of the selected search target face 62 is added to stack 1 and the measurement target face group.

The above processing is repeated in accordance with the flow chart of FIG. 5. In step S210, it is determined whether all the faces included in the search target face group have been evaluated. If not, processing is repeated from step S205. If already evaluated, then proceeding to step S211, it is determined whether stack 1 is empty. If stack 1 is not empty, processing is repeated from step S202.

In the repeated processing, again in step S202, a search base face 61 is extracted from stack 1. At this time, the new search base face 61 may not include the measurement base point (e.g., first position P1). A search target face 62 is calculated based on the newly extracted search base face 61. Then, the calculated search base face group is evaluated.

Such processing is repeated to obtain a measurement target face group. For instance, a measurement target face group 51 corresponding to the first position P1 and a measurement target face group 52 corresponding to the second position P2 are obtained (see FIG. 4).

In the example of FIG. 4, the measurement target face group 51 is composed of six triangular faces 41. The measurement target face group 52 is composed of other six triangular faces 41. However, in the embodiment, the triangular faces 41 constituting the measurement target face group are not limited to this example.

As seen from the above processing, at least one measurement target face group is calculated for one measurement base point. There are as many measurement target face groups as at least the number of measurement base points.

(Step S104)

The candidate viewpoint position calculator 31 calculates (a set of) candidate viewpoints from the measurement base point, the line segment, and the measurement target face group determined in step S103. The candidate viewpoint is a candidate of the viewpoint used for final rendering. For instance, the viewpoint includes a viewpoint position, a point-of-regard position, and the above-mentioned orientation vector.

The calculation of candidate viewpoints broadly includes e.g. the following three steps.

(Step 1) The step of determining a candidate viewpoint base position. The candidate viewpoint base position is a viewpoint serving as a base for candidate viewpoint calculation.

(Step 2) The step of determining a viewpoint position and a point-of-regard position. These are determined by coordinate transformation of the candidate viewpoint base position ViewPoint_base using the rule described later.

(Step 3) The step of calculating an orientation vector from the information determined so far.

(Step 1) First, a representative point is determined for each measurement target face group. This calculation of the representative point determines e.g. the average value of the coordinates of the vertices constituting the measurement target face group. The point corresponding to the average coordinates is denoted by pf. Furthermore, a representative point pl is determined for each line segment of the measurement information data. The representative point pl is e.g. the midpoint of the line segment.

For instance, in the example shown in FIG. 4, the average value of the coordinates of the vertices of the triangular faces constituting the measurement target face group 51 constitutes a representative point pf (representative point pf1). The average value of the coordinates of the vertices of the triangular faces constituting the measurement target face group 52 constitutes a representative point pf (representative point pf2).

In the following, the set of position coordinates of representative points pf is denoted by set PF. The set of position coordinates of representative points pl is denoted by set PL. The set of position coordinates of measurement base points is denoted by set PM. The number of elements of the set PF is equal to the number of elements of the set PM. The number of elements of the set PL is half the number of elements of the set PF.

The union of the set PF, the set PL, and the set PM is denoted by set Peval (=PF 520 PL 520 PM). A point p_center is determined by averaging the elements of the set Peval. Furthermore, principal component analysis is performed on the set Peval to determine principal axes (eigenvectors). In the following description, the principal axes are referred to as first principal axis vec1, second principal axis vec2, and third principal axis vec3 in the decreasing order of the corresponding eigenvalues. Thus, the principal axes determined based on the shape data and the measurement information data are coordinate axes serving as a reference for calculating a plurality of candidate viewpoints. Specifying such coordinate axes facilitates calculating a suitable viewpoint position.

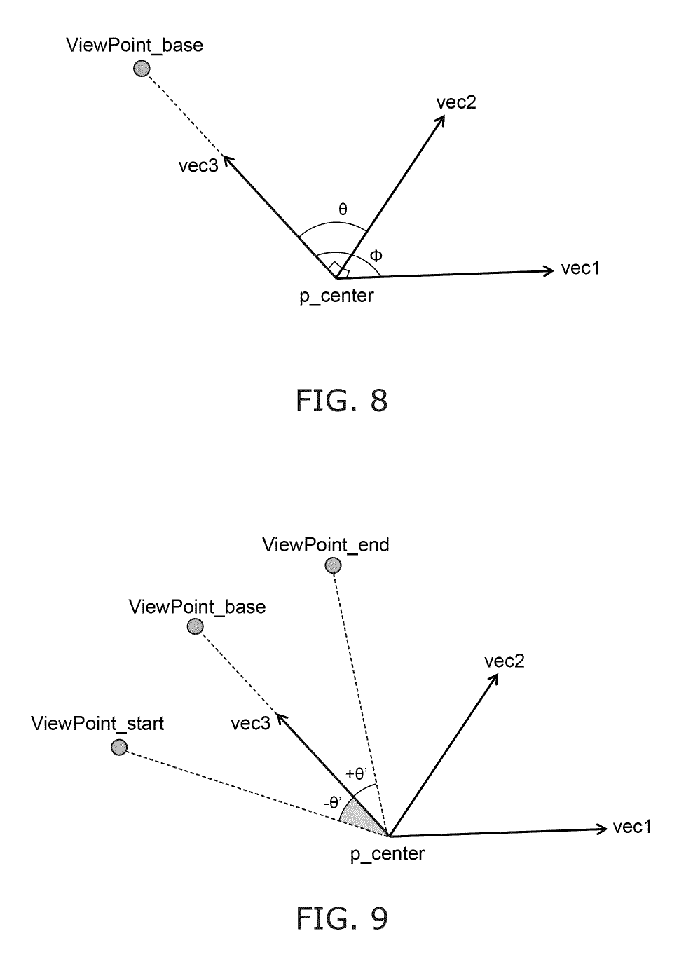

FIG. 8 is a schematic view illustrating the calculation of a candidate viewpoint position according to the first embodiment.

The following equation (1) is used to calculate ViewPoint_base.

ViewPoint_base=p_center+α×(Distance)×vec3 (1)

In equation (1), ViewPoint_base is the coordinate of the candidate viewpoint base position, p_center is the coordinate of the point obtained by averaging the elements of the set Peval, and vec3 is the vector representing the third principal axis vec3. Distance is the maximum of the distance between the point p_center and the elements of the set Peval. The number α is a real number of 1 or more. With the increase of the value of α, the output image covers a larger region of the object.

(Step 2) As shown in FIG. 8, the rotation angle about the first principal axis vec1 is denoted by θ. The rotation angle about the second principal axis vec2 is denoted by φ. The candidate viewpoint base position ViewPoint_base is rotated within the range of predetermined rotation angles θ′, φ′ about the respective axes. Thus, the viewpoint position of the candidate viewpoint is calculated.

FIG. 9 is a schematic view illustrating the calculation of the candidate viewpoint position according to the first embodiment.

Specifically, first, as shown in FIG. 9, the candidate viewpoint base position ViewPoint_base is rotated by −θ′ about the first principal axis vec1. Thus, the position ViewPoint_start is determined. Then, the position ViewPoint_start is repetitively rotated to +θ′ in increments of Δθ. Thus, a set V_{θ} representing viewpoint positions between the position ViewPoint_start and the position ViewPoint_end is obtained.

Next, the position is rotated also for the rotation angle φ about the second principal axis vec2 in increments of Δφ to obtain a set V_{θφ}. However, at this time, the elements of the set V_{θ} are used instead of the candidate viewpoint base position ViewPoint_base. That is, the processing of viewpoint position generation by rotation about the second principal axis vec2 is repeated the number of times equal to the number of elements of the set V_{θ}.

Finally, for the elements of the set V_{θφ}, a set V_{rθφ} of positions symmetric with respect to the point p_center is calculated. The viewpoint position of the candidate viewpoint is defined as the union VP of the set V_{θφ} and the set V_{rθφ}.

For each viewpoint position calculated in the above processing, the position look of a point-of-regard is calculated by the following equation (2). The point-of-regard is determined based on the viewpoint position of the candidate viewpoint, the measurement information data, and the shape data.

look_i=k×near_i+l×far_i (2)

Here, k+l=1.0. An element of the set VP is denoted by vp_i (i being the serial number of the elements). The line passing through the element vp_i and the point p_center is denoted by l_{eye}. Here, near_i is (the coordinate of) the foot of the normal to the line l_{eye} from the element of the set Peval nearest to the element vp_i. The value far_i is (the coordinate of) the foot of the normal to the line l_{eye} from the element of the set Peval farthest from the element vp_i. One point-of-regard is calculated for each element of the set VP.

(Step 3) First, a line-of-sight vector Vₗₒₒₖ is determined from the element vp_i and the corresponding point-of-regard. Next, the outer product of a previously given base orientation vector Vᵤₚ_{_}_{base} and the line-of-sight vector Vₗₒₒₖ is determined. The outer product of the resulting vector and the line-of-sight vector Vₗₒₒₖ is further determined. Thus, an orientation vector Vᵤₚ is determined.

The base orientation vector Vᵤₚ_{_}_{base} and the line-of-sight vector Vₗₒₒₖ may be in the same direction or directly opposite direction. In this case, for instance, the base orientation vector Vᵤₚ_{_}_{base} is rotated by a small angle (within the range of e.g. less than Δθ or less than Δφ) about the first principal axis vec1 or the second principal axis vec2. Thus, an orientation vector Vᵤₚ can be stably determined.

Finally, this vector is corrected by the value of the inner product of the base orientation vector Vᵤₚ_{_}_{base} and the orientation vector Vᵤₚ. Specifically, for instance, when the value of the inner product of the base orientation vector Vᵤₚ_{_}_{base} and the orientation vector Vᵤₚ is negative, Vᵤₚ is set to Vᵤₚ=−Vᵤₚ. The above processing is performed on each element of the set VP. Thus, as many orientation vectors Vᵤₚ are calculated as the number of elements of the set VP.

In the above example, the base orientation vector Vᵤₚ_{_}_{base} is previously given. However, the embodiment is not limited thereto. For instance, the first principal axis (vector) vec1 or the second principal axis (vector) vec2 described above may be used as the base orientation vector Vᵤₚ_{_}_{base}.

(3-2) Evaluation Shape Generator 32

The evaluation shape generator 32 generates evaluation shape data related to an evaluation shape composed of a set of triangular faces based on the measurement information data.

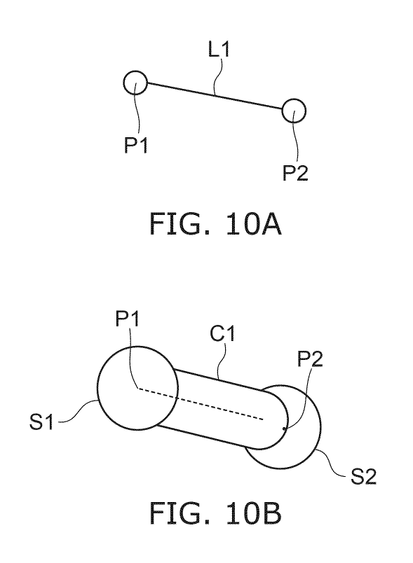

FIG. 10A and FIG. 10B are schematic views illustrating an evaluation shape according to the first embodiment.

In the evaluation value calculator 33 described later, the shape data, and the line segment constituting part of the measurement information data, are projected on a plane. Then, viewability is evaluated by the proportion of the area that the portion corresponding to the measurement information data occupies on the plane. At this time, the line segment as shown in FIG. 10A is not directly rendered, but the evaluation shape as shown in FIG. 10B is rendered. The evaluation shape is a shape representing the line segment shown in FIG. 10A. Such an evaluation shape is used for evaluation.

The evaluation shape is composed of a combination of a sphere and a cylinder represented by triangular faces. First, a sphere having a predetermined radius rs is generated with the center at the endpoint of the line segment. With the increase of this radius rs, the evaluation value is likely to increase when the neighborhood of the endpoint is viewed. Next, a cylinder having a predetermined radius rc is generated with the central axis on the line segment. With the increase of the radius rc, the evaluation value is likely to increase when the neighborhood of the line segment is viewed. The evaluation shape is in one-to-one correspondence with the line segment. Thus, there are as many evaluation shapes as the number of line segments. The accuracy of evaluation can be improved by suitably specifying the radius rs and the radius rc.

For instance, a sphere of radius rs with the center at the first position P1 is referred to as first sphere S1. A sphere of radius rs with the center at the second position P2 is referred to as second sphere S2. The cylinder with the central axis on the line segment L1 is referred to as cylinder C1. In this case, the evaluation shape data corresponding to the first measurement information data includes information on at least part of the first sphere S1, the second sphere S2, and the cylinder C1.

(3-3) Evaluation Value Calculator 33

The evaluation value calculator 33 calculates a viewpoint evaluation value (evaluation value of viewability) for each candidate viewpoint based on the shape data and the measurement information data. The viewpoint evaluation value is calculated in accordance with the relative positional relationship between the shape data and the line segment data.

Specifically, the evaluation value calculator 33 renders the shape data and the evaluation shape data using each candidate viewpoint. Then, the evaluation value calculator 33 calculates the evaluation value of viewability based on the proportion of the evaluation shape data occupying the rendering result.

First, the evaluation value calculator 33 selects one unevaluated candidate viewpoint from a plurality of candidate viewpoints (set VP) (step S105). The selected candidate viewpoint is used to project the shape data, the evaluation shape, (and the measurement target face group). The evaluation value of viewability is calculated based on the projection area of the evaluation shape data (step S106). The calculation of the evaluation value is performed for each candidate viewpoint (step S107).

The viewpoint evaluation value is based on e.g. the viewpoint entropy E represented by equation (3). The viewpoint entropy E is based on the projection area of the evaluation shape represented by the evaluation shape data on the projection surface.

$$\begin{matrix}[ Math 1 ] & \\ E = - {\sum }_{i} ( \frac{Area\_i}{Area\_t} \times {log}_{2} \frac{Area\_i}{Area\_t} ) & ( 3 )\end{matrix}$$

Area_i: Projection area of the evaluation shape

Area_t: Projection area of the shape data

i: Number of line segment data (=number of evaluation shapes)

The evaluation value calculator 33 calculates a projection surface for each of the plurality of candidate viewpoints. The projection surface is a plane perpendicular to the line-of-sight vector defined by a viewpoint (vp_i) and the corresponding point-of-regard (look_i). Area_i and Area_t are calculated by sequentially projecting the triangular faces constituting each shape. Thus, the viewpoint entropy E is calculated in the number of elements of the set VP.

As described above, a plurality of viewpoint evaluation values related respectively to the plurality of candidate viewpoints is calculated. For example, the plurality of candidate viewpoints includes a first candidate viewpoint, and the projection surface for the first candidate viewpoint is calculated. The plurality of viewpoint evaluation values includes a first evaluation value (the viewpoint evaluation value related to the first candidate viewpoint) based on the projection area of the evaluation shape on the projection surface.

In the above processing, Area_i is larger as the direction of the normal vector of the triangular face constituting the evaluation shape and the direction of the line-of-sight vector is closer to directly opposite. In the case of displaying the back surface of the triangular face, Area_i is larger as the direction of the normal vector of the triangular face constituting the evaluation shape and the direction of the line-of-sight vector is closer to parallel.

As the viewpoint position is closer to the evaluation shape, the triangular face is projected larger, and hence Area_i is also larger. Thus, it is considered that the viewpoint entropy E is larger at a viewpoint where the evaluation shape faces the line-of-sight vector as directly as possible and is viewed larger.

In the example described above, only the evaluation shape is used to determine Area_i. However, the embodiment is not limited thereto. For instance, part of the shape data (measurement target face group) may be used in addition to the evaluation shape. This can further improve the accuracy of evaluation. This can be achieved as follows. Like the evaluation shape, the triangular face corresponding to the measurement target face group is projected on the projection surface. Then, the projection area is added to Area_i. That is, in the aforementioned equation, Area_i is set to the projection area of both the evaluation shape and the measurement target face group.

In this case, for instance, the evaluation shape data further includes information on part of the extracted shape data (measurement target face group). The measurement target face group is based on e.g. the normal vector 61n. The normal vector 61n is e.g. a vector passing through the intersection point of the line segment L1 and the surface of the object based on the shape data and being perpendicular to the surface of the object based on the shape data. The measurement target face group used herein can be the measurement target face group determined by the candidate viewpoint position calculator 31. For instance, the information of the measurement target face group is passed from the candidate viewpoint position calculator 31 to the evaluation shape generator 32. Alternatively, the evaluation shape generator 32 may recalculate a measurement target face group.

However, the triangular face corresponding to the measurement target face group is part of the shape data. Thus, determination of Area_t is configured so that Area_t does not include the projection area of the triangular face corresponding to the measurement target face group. This can be achieved as follows. At the stage of projecting each triangular face in order to calculate Area_t, it is examined whether the face ID of the triangular face under processing is included in the measurement target face group. If it is included, the processing is skipped.

(3-4) Viewpoint Position Selector 34

The viewpoint position selector 34 selects a candidate viewpoint maximizing the evaluation value determined for each candidate viewpoint in the evaluation value calculator 33. The selected candidate viewpoint is used as a final viewpoint (step S108).

That is, the viewpoint position selector 34 selects a viewpoint to be used in the display image generator 4. This is based on the candidate viewpoints calculated in the candidate viewpoint position calculator 31 and the viewpoint entropy E determined for each candidate viewpoint in the evaluation value calculator 33. Specifically, an element vp maximizing the viewpoint entropy E, and a point-of-regard position look and an orientation vector Vup corresponding thereto, are selected from the set VP.

(4) Display Image Generator 4

The display image generator 4 renders the shape data acquired in the shape acquisitor 1 and the line segment data acquired in the measurement information acquisitor 2. This is based on the viewpoint and the point-of-regard calculated in the viewpoint position calculator 3, and the orientation vector (step S109). In the above method, the line segment data is directly projected. However, the endpoint of the line segment data may be replaced by a sphere having a predetermined radius, and the line segment data may be represented by a cylinder. The thickness as projected on the plane may be adjusted.

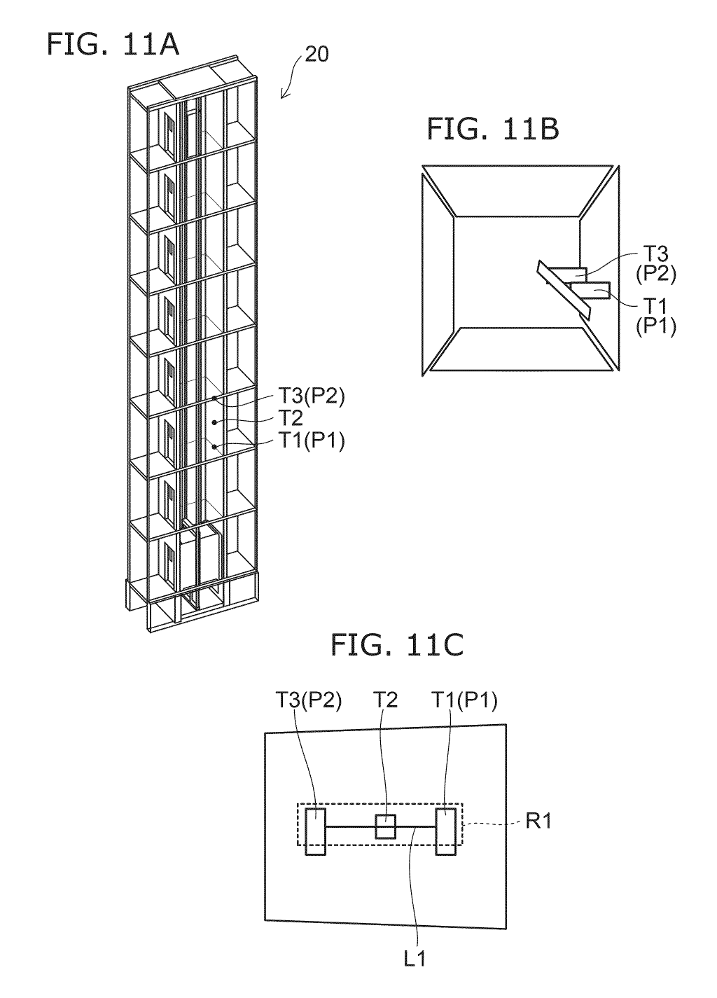

FIG. 11A to FIG. 11C are schematic views illustrating the operation of an image generation device.

FIG. 11A illustrates an elevator shaft 20 represented by shape data. For instance, a member T1, a member T2, and a member T3 are provided on the inner wall of the elevator shaft 20. The members T1-T3 are arranged in the vertical direction of the elevator. For instance, each of the members T1-T3 is a member grasping the rail of the elevator. FIGS. 11B and 11C illustrate the result of rendering the shape data shown in FIG. 11A.

Here, consider the case of measuring the distance between the member T1 and the member T3. That is, in this case, the aforementioned first measurement base point (first position P1) is located on the member T1. The aforementioned second measurement base point (second position P2) is located on the member T3.

FIG. 11B illustrates an image generated by an image generation device of a reference example. The viewpoints used to generate the image shown in FIG. 11B are arranged on the members T1-T3 in the vertical direction of the elevator. That is, in this case, the line-of-sight vector directed from the viewpoint toward the point-of-regard is generally parallel to the vertical direction of the elevator.

As shown in FIG. 11B, the member T2 located between the member T1 and the member T3 is hidden by the member T1. Thus, the member T2 may be erroneously selected in trying to select the member T1 and the member T3 to measure the distance therebetween on the image of FIG. 11B. For instance, the distance between the member T1 and the member T2 may be measured, failing to obtain the correct measurement result. That is, in the example of FIG. 11B, it is difficult to confirm whether the intended site is selected in selecting the measurement site.

FIG. 11C illustrates an image generated by the image generation device 210 according to the embodiment. The viewpoints used to generate the image shown in FIG. 11C are arranged on the members T1-T3 in e.g. the horizontal direction. That is, in this case, the line-of-sight vector directed from the viewpoint toward the point-of-regard crosses the vertical direction of the elevator. For instance, the line-of-sight vector is generally perpendicular to the line segment connecting the member T1 with the member T3. The image of FIG. 11C includes the image of a first region R1 of the object including the first position P1 and the second position P2, and the image of the line segment L1. Thus, the positional relationship between the member T1 and the member T3 is easy to confirm on the image of FIG. 11C. It is easy to confirm that the member T1 and the member T3 are selected on the image of FIG. 11C. Thus, a display in which the measurement site is easily viewable can be obtained by using the viewpoint calculated by the viewpoint position calculation device 110.

With the recent aging of social infrastructures, there is an increasing requirement for their maintenance, management, and repair. The elevator, one of familiar infrastructures, is no exception, and there is an increasing demand for its replacement. Facilities constituting the elevator to be replaced already exist at the time of replacement. In order to replace them by new facilities, the dimensions of the existing facilities are measured to determine a building material suitable for the elevator shaft. However, from the viewpoint of convenience of the building, it is difficult to stop the operating elevator for a long time. Thus, conventionally, the measurement work can be performed only by limited expert engineers.

In this respect, attempts have been made to acquire a three-dimensional shape data in an elevator shaft using equipment such as a laser range finder. The laser range finder can measure the three-dimensional distance from a location to an object. In the following, the method using such equipment is referred to as three-dimensional measurement. This method has advantages as follows. The time for stopping the elevator is short. No skilled technique is required. The shape in the elevator shaft can be reconfirmed at the stage of making a replacement plan.

The data finally required for replacement are dimensions. Thus, in the latter case, the dimension is measured later from the shape data. What is measured in a typical replacement work includes e.g. the inner dimension between the wall surfaces, the distance to the wall surface from the rail attached to control the traveling direction of the elevator cage (hereinafter cage), and the distance between the brackets attached at regular spacings on the wall surface to support the rail. As described above, measurement can be performed by e.g. the method of selecting the sites to be measured on the shape data displayed on the display.

Only the shape data may be insufficient to grasp what the object is like. Thus, attempts have also been made to facilitate specifying measurement base points by taking a picture of the inside of the elevator shaft at the time of measurement and displaying the picture with the shape data. For instance, a camera directed to the elevator shaft ceiling is placed on the cage to take a picture. The rendering result of the shape data is superimposed on the taken picture. This can provide a display such that the inside of the elevator shaft is viewed upward from the top of the cage. Thus, measurement base points can be specified with a feeling like selecting a portion of the picture.

In the case of obtaining dimensions from the shape data by the aforementioned method, the measurement position is determined from the rendering result displayed on the display. Thus, it is confirmed whether the measurement has been performed at the correct measurement position. As described above, this is assisted by the camera picture. However, the information of the camera is of no help in the case where the measurement site is hidden from the viewpoint of the camera or in the case of setting a measurement base point near the boundary between the front side and the object behind. Thus, the operator performing the measurement manipulates the viewpoint for rendering the shape data to search for a viewpoint from which the measurement position can be confirmed.

This work requires the operator to get accustomed to the manipulation and to have knowledge on computer graphics. This is considered to be a great obstacle to the introduction of three-dimensional measurement. Furthermore, it is said that replacement work requires measurement at at least 20 or more sites. Optimal viewpoints should be determined at all these sites. This work causes the decrease of work efficiency.

As a method for determining a viewpoint suitable to confirm a particular portion on a three-dimensional shape, there is a reference example of assuming the creation of a guide map of a station premise. Here, an intersection point of the path and the shape data is determined. An evaluation model is created based on the normal vector at the intersection point. The created evaluation model and the three-dimensional data of the station premise are combined and rendered using predefined candidate viewpoint positions. The viewpoint maximizing the proportion of the evaluation model occupying the result image of the rendering is taken as an optimal viewpoint. Thus, the viewpoint is automatically determined. However, in view of measurement, the evaluation model determined from the normal vector at the intersection point is not suitable to evaluate the viewability of a line segment. Thus, a suitable viewpoint position cannot be obtained by directly using the method of the reference example.

In contrast, in the embodiment, a viewpoint used for rendering is calculated based on the shape data and the measurement information data. In calculating the viewpoint, the viewability of a line segment included in the measurement information data is evaluated as in steps S103-S108. This generates an image displaying the measurement base points, the line segment connecting the measurement base points, and a region of the object including the measurement base points in an easily viewable manner.

In the above description, the object is an elevator shaft. However, the embodiment is not limited thereto. The object may be a building such as a factory. For instance, many facilities and pipings are placed in the factory. The viewpoint position calculation device and the image generation device according to the embodiment may be used to measure the distance between the pipings.

### Second Embodiment

In the example described in the first embodiment, when a plurality of measurement information data are defined, a suitable viewpoint is calculated for all the measurement information data. That is, a viewpoint suitable to display a plurality of measurement information data and part of the shape data related thereto is calculated. In contrast, in this embodiment, part of the plurality of measurement information data are selected. A suitable viewpoint is calculated for the selected measurement information data.

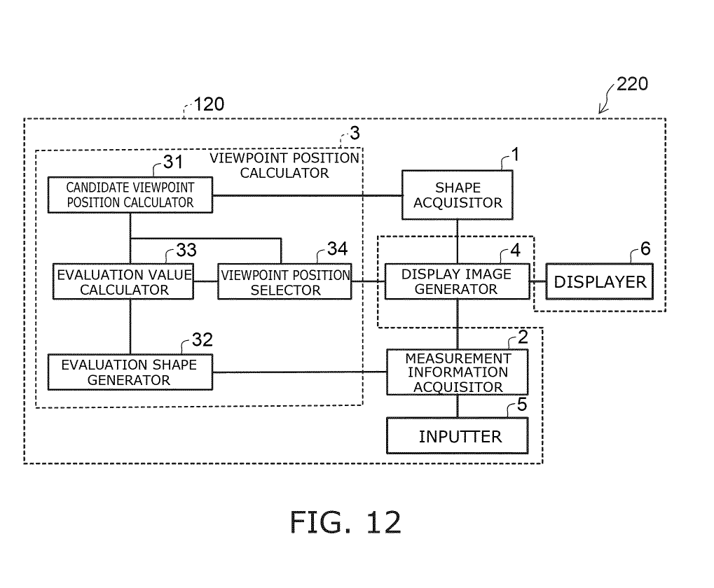

FIG. 12 is a block diagram illustrating a viewpoint position calculation device and an image generation device according to a second embodiment.

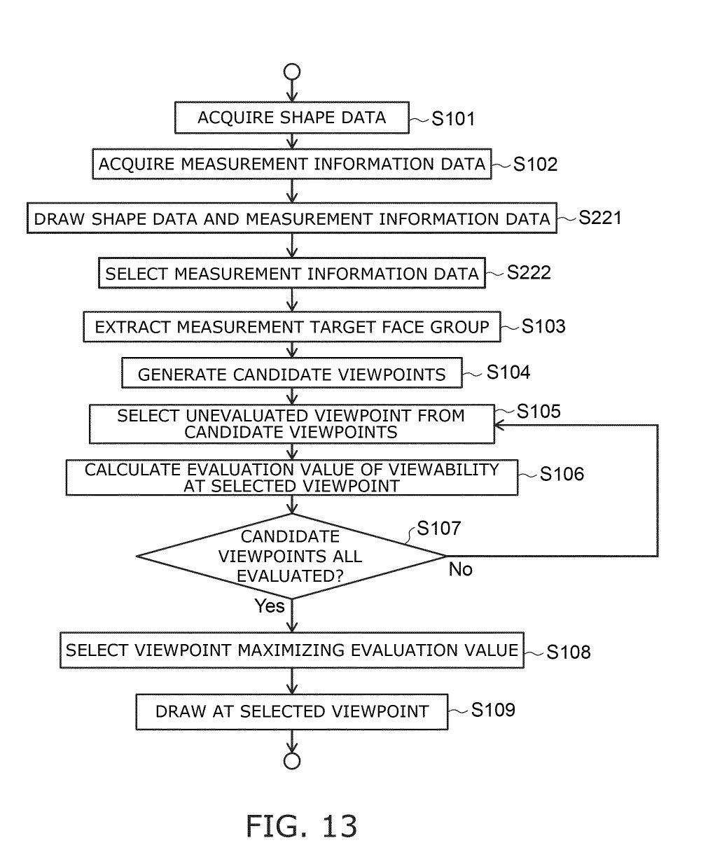

FIG. 13 is a flow chart illustrating viewpoint position calculation and image generation according to the second embodiment.

As shown in FIG. 12, the image generation device 220 according to this embodiment includes a viewpoint position calculation device 120 and a display image generator 4. As in the first embodiment, the viewpoint position calculation device 120 includes a shape acquisitor 1, a measurement information acquisitor 2, and a viewpoint position calculator 3. The viewpoint position calculation device 120 further includes an inputter 5 and a displayer 6.

This embodiment is different from the first embodiment in including the inputter 5 and the displayer 6. Part of a plurality of measurement information data are selected by the inputter 5 and the displayer 6.

The displayer 6 is a display device for selecting measurement information data acquired by the measurement information acquisitor 2. The displayer 6 displays an image rendering at least part of the shape data, and the measurement information data. The display device includes e.g. various display equipment such as CRT (cathode ray tube) or flat display panel (liquid crystal panel or LED (light emitting diode) panel). The displayer 6 also includes e.g. a communication network and a transmitter/receiver used to operate the above display equipment in a remote or cableless manner.

The inputter 5 is an input device for selecting measurement information data acquired by the measurement information acquisitor 2. A select signal for selecting measurement information data is inputted from the inputter 5. The inputter 5 includes various devices such as a touch pen, touch panel, mouse, keyboard, or microphone. The inputter 5 also includes e.g. a communication network and a transmitter/receiver used to operate the above devices in a remote or cableless manner.

As shown in FIG. 13, the processing of the viewpoint position calculation device 120 according to this embodiment includes steps S101-S109 as in the first embodiment. The processing further includes step S221 for drawing the shape data and the measurement information data, and step S222 for selecting measurement information data.

In step S101, as in the first embodiment, the shape acquisitor 1 acquires shape data. In step S102, the measurement information acquisitor 2 acquires a plurality of measurement information data. For instance, the plurality of measurement information data include a first measurement information data.

In step S221, an image is generated by the display image generator 4 based on the shape data and a plurality of shape information data. The generated image is displayed on the displayer 6.

In step S222, part of a plurality of measurement information data are selected through the inputter 5 based on the image displayed on the displayer 6. For instance, images corresponding to the plurality of measurement information data are displayed on the displayer 6. The user selects a first measurement information data from the plurality of measurement information data. The measurement information acquisitor 2 acquires the first measurement information data based on the select signal inputted from the inputter 5. Then, as in the first embodiment, a viewpoint is calculated in accordance with the selected measurement information data and part of the shape data corresponding to the measurement information data. Thus, an easily viewable image is provided.

To determine which measurement information data is selected, for instance, it is previously determined which measurement information data corresponds to the projected pixel at the time of projection on the projection surface. This enables acquisition of the measurement information data at the position selected by the inputter 5.

The vector to the selected pixel from the viewpoint position at the time of rendering may be sufficiently close to the line segment of the measurement information data. In this case, the measurement information data corresponding to the line segment may be acquired. At this time, the measurement information data may be selected by prompting the user to directly select the line segment displayed on the display. Alternatively, the user may be prompted for selection from a displayed list of measurement information data. The selection is performed by the inputter 5. Part of the measurement information data selected by the above processing are used as measurement information data for determining a suitable viewpoint.

### Third Embodiment

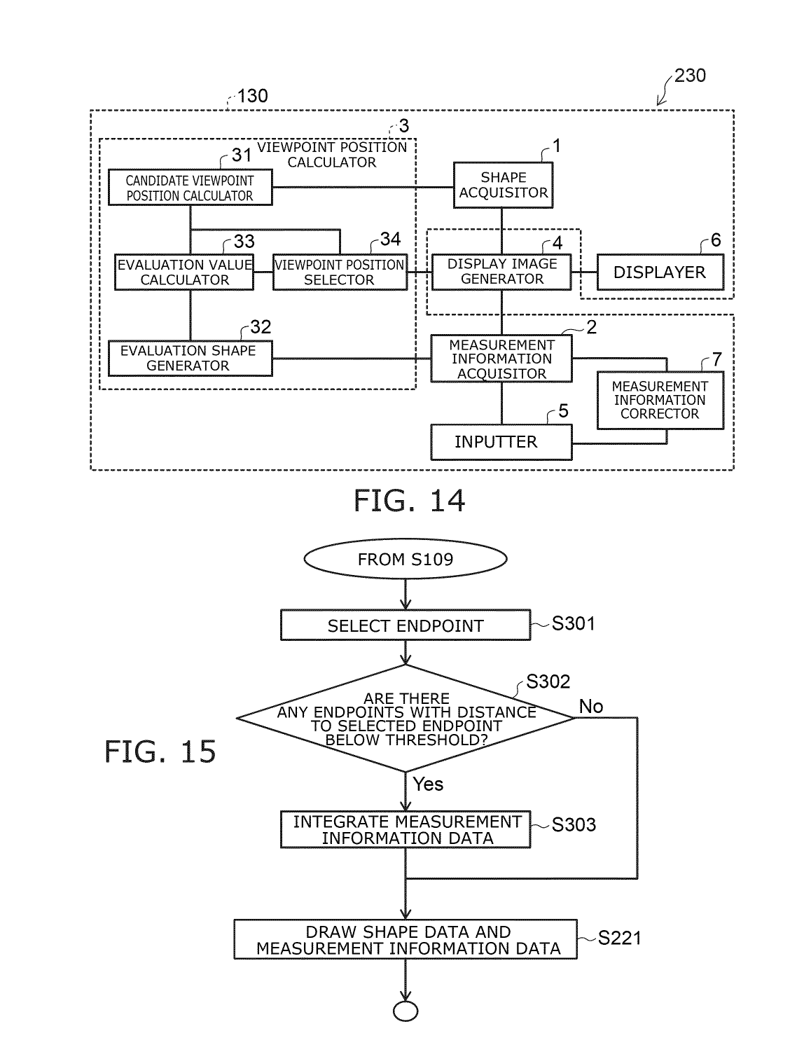

FIG. 14 is a block diagram illustrating a viewpoint position calculation device and an image generation device according to a third embodiment.

As shown in FIG. 14, the image generation device 230 according to this embodiment includes a viewpoint position calculation device 130 and a display image generator 4. Like the viewpoint position calculation device 120 according to the second embodiment, the viewpoint position calculation device 130 includes a shape acquisitor 1, a measurement information acquisitor 2, a viewpoint position calculator 3, an inputter 5, and a displayer 6. The viewpoint position calculation device 130 further includes a measurement information corrector 7.

The viewpoint position calculation device according to the third embodiment is different from those of the first and second embodiments in including a measurement information corrector 7 for correcting the measurement information data.

In the third embodiment, an endpoint of the measurement information data to be corrected is selected based on the image rendered from the viewpoint determined by the viewpoint position calculator 3. Then, the measurement information corrector 7 corrects the measurement information data. The display image generator 4 generates a display image based on the corrected measurement information data.

FIG. 15 is a flow chart illustrating viewpoint position calculation and image generation according to the third embodiment. FIG. 15 illustrates part of the processing of the viewpoint position calculation device 130 according to this embodiment. The processing of the viewpoint position calculation device 130 includes steps S101-S109, step S221, and step S222 as in the second embodiment.

The processing of the viewpoint position calculation device 130 further includes step S301, step S302, and step S303.

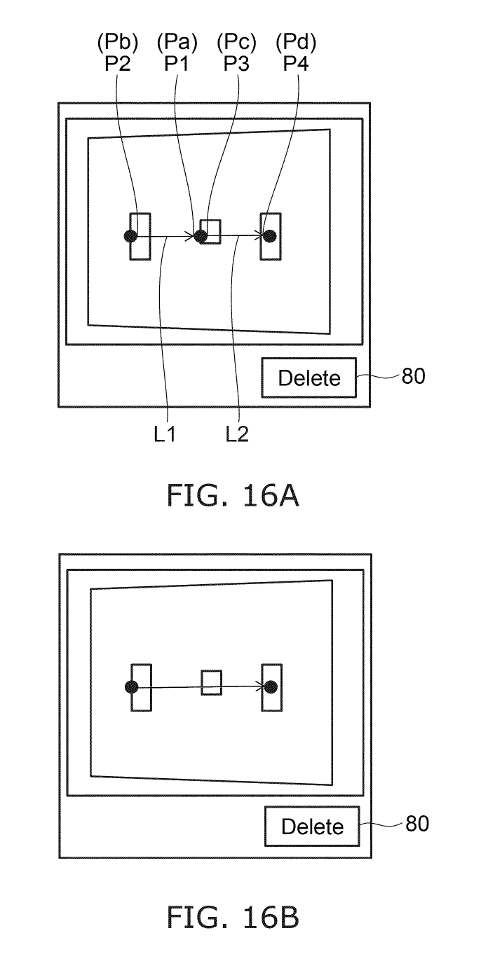

FIG. 16A and FIG. 16B are schematic views illustrating the operation of the viewpoint position calculation device and the image generation device according to the third embodiment.

First, as in the second embodiment, in step S109, the shape data and a plurality of measurement information data are rendered by the display image generator 4.

For instance, the plurality of measurement information data include a first measurement information data and a second measurement information data. The first measurement information data includes data related to a first measurement base point (first position P1), a second measurement base point (second position P2), and a line segment L1. The object further includes a third portion Pc located at a third position P3 and a fourth portion Pd located at a fourth position P4. The second measurement information data includes data related to a third measurement base point (third position P3), a fourth measurement base point (fourth position P4), and a line segment L2 connecting the third position P3 with the fourth position P4. Thus, for instance, an image as shown in FIG. 16A is displayed on the displayer 6.

Next, select information for selecting part of the plurality of displayed measurement base points (endpoints of line segments) is inputted from the inputter 5. The measurement information corrector 7 acquires the selected measurement information data. For instance, in the example of FIG. 16A, the first measurement base point belonging to the first measurement information data is selected from the plurality of measurement base points.

To determine which measurement information data is selected, for instance, it is previously determined which measurement information data corresponds to the projected pixel at the time of projection on the projection surface. This enables acquisition of the measurement information data at the position selected by the inputter 5.

The vector to the selected pixel from the viewpoint position at the time of rendering may be sufficiently close to the line segment of the measurement information data. In this case, the measurement information data corresponding to the line segment may be acquired. At this time, the measurement information data may be selected by prompting the user to directly select the line segment displayed on the display. Alternatively, the user may be prompted for selection from a displayed list of measurement information data.

Next, in step S302, a measurement base point nearest to the first measurement base point is calculated among the measurement base points belonging to measurement information data different from the first measurement information data to which the first measurement base point selected in step S301 belongs.

For instance, the third measurement base point belonging to the second measurement information data is selected in the example of FIG. 16A.

Then, the first distance between the calculated third measurement base point and the first measurement base point is calculated. If the first distance is shorter than a predetermined threshold, then in step S303, the first measurement information data and the second measurement information data are integrated.

This integration can be performed by replacing the position coordinates of the first measurement base point by the position coordinates of the fourth measurement base point, and then deleting the second measurement information data. Thus, as shown in FIG. 16B, the measurement information corrector 7 integrates the first measurement information data and the second measurement information data based on the select signal inputted from the inputter 5. That is, a line segment is defined so that the second measurement base point and the fourth measurement base point are its endpoints. Measurement information data related to the line segment is generated as new first measurement information data.

A UI such as a button may be separately provided on the display image. In the above example, step S302 is automatically performed after step S301. However, step S302 may be triggered by selection of UI to perform processing. For instance, a Delete button 80 is provided. The processing of step S302 may be performed by selecting the Delete button 80.

As described above, the embodiments use measurement information data related to two measurement base points and a line segment connecting them. Thus, the user can appropriately correct or modify the site to be measured using the inputter 5 and the displayer 6.

The image generation device and the viewpoint position calculation device according to the embodiments can be based on a control device such as CPU, a storage device such as ROM and RAM, an external storage device such as HDD (hard disk drive) and SSD (solid state drive), and a display device such as a display. The image generation device according to the embodiments may be implemented using a general-purpose computer device as its hardware. Each block may be implemented in software or hardware.

The viewpoint position calculation device, the image generation device, the viewpoint position calculation method, and the image generation method have been described above as embodiments. However, the embodiments may be in the form of a program causing a computer to execute the above methods, or in the form of a computer-readable storage medium with this program recorded thereon.

The storage medium can be e.g. CR-ROM (-R/-RW), magneto-optical disk, HD (hard disk), DVD-ROM (-R/-RW/-RAM), FD (flexible disk), flash memory, memory card, memory stick, and other various ROM and RAM.

The embodiments can provide a viewpoint position calculation device, an image generation device, a viewpoint position calculation method, an image generation method, and a non-transitory recording medium providing an easily viewable image from three-dimensional shape data.

Hereinabove, embodiments of the invention are described with reference to specific examples. However, the invention is not limited to these specific examples. For example, one skilled in the art may similarly practice the invention by appropriately selecting specific configurations of components included in the shape acquisitor, the measurement information acquisitor, the viewpoint position calculator, the display image generator, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all viewpoint position calculation devices, image generation devices, viewpoint position calculation methods, image generation methods, and non-transitory recording mediums practicable by an appropriate design modification by one skilled in the art based on the viewpoint position calculation devices, the image generation devices, the viewpoint position calculation methods, the image generation methods, and the non-transitory recording mediums described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A viewpoint position calculation device comprising:
a shape acquisitor configured to acquire a shape data representing a three-dimensional shape of an object including a first portion and a second portion, the shape data including information on a first position of the first portion and a second position of the second portion;
a measurement information acquisitor configured to acquire a first measurement information data including a line segment data related to a line segment connecting the first position with the second position, the line segment corresponding to a length subjected to measurement; and
a viewpoint position calculator configured to calculate a viewpoint based on the shape data and the first measurement information data,
a first image of the object as viewed from the viewpoint being generated based on the shape data and the line segment data, the first image including an image of a first region of the object and an image of the line segment, the first region including the first position and the second position.

2. The device according to claim 1, wherein the viewpoint position calculator includes:
a candidate viewpoint position calculator configured to calculate a plurality of candidate viewpoints based on the shape data and the first measurement information data, the candidate viewpoints serving as candidates of the viewpoint;
an evaluation shape generator configured to generate an evaluation shape data based on the first measurement information data;
an evaluation value calculator configured to calculate a plurality of viewpoint evaluation values based on the shape data and the evaluation shape data, the viewpoint evaluation values being related to the candidate viewpoints and corresponding to relative positional relationship between the shape data and the line segment data; and
a viewpoint position selector configured to calculate the viewpoint from the candidate viewpoints based on the viewpoint evaluation values.

3. The device according to claim 2, wherein
the candidate viewpoint position calculator calculates a coordinate axis based on the shape data and the first measurement information data, and
the coordinate axis serves as a reference for calculating the candidate viewpoints.

4. The device according to claim 2, wherein the evaluation shape data includes information on at least part of a first sphere with a center at the first position, a second sphere with a center at the second position, and a cylinder with an axis on the line segment.

5. The device according to claim 4, wherein
the evaluation shape data further includes information of part of the shape data, and
the part of the shape data is extracted based on a vector, the vector passing through an intersection point of the line segment and a surface of the object based on the shape data, the vector being perpendicular to the surface of the object based on the shape data.

6. The device according to claim 2, wherein
the evaluation value calculator calculates a projection surface for a first candidate point of the candidate viewpoints,
the viewpoint evaluation values includes a first evaluation value and
the first evaluation value is based on a projection area of an evaluation shape on the projection surface, the evaluation shape being based on the evaluation shape data.

7. The device according to claim 1, further comprising:
a displayer configured to display the first image rendering at least part of the shape data, and the first measurement information data.

8. The device according to claim 1, further comprising:
an inputter,
wherein the measurement information acquisitor acquires the first measurement information data based on a select signal inputted from the inputter.

9. The device according to claim 1, further comprising:
an inputter; and
a measurement information corrector,
wherein the object further includes a third portion and a fourth portion, and
the measurement information corrector integrates second measurement information data and the first measurement information data based on a select signal inputted from the inputter, the second measurement information data being related to a line segment connecting a third position of the third portion with a fourth position of the fourth portion.

10. An image generation device comprising:
the viewpoint position calculation device according to claim 1; and
a display image generator configured to generate the first image based on the viewpoint, the shape data, and the line segment data.

11. An image generation device comprising:
a shape acquisitor configured to acquire a shape data representing a three-dimensional shape of an object including a first portion and a second portion, the shape data including information on a first position of the first portion and a second position of the second portion;
a measurement information acquisitor configured to acquire a first measurement information data including a line segment data related to a line segment connecting the first position with the second position, the line segment corresponding to a length subjected to measurement; and
a display image generator configured to generate a first image based on the shape data and the first measurement information data, the first image including an image of a first region of the object and an image of the line segment, the first region including the first position and the second position.

12. A viewpoint position calculation method comprising:
acquiring a shape data representing a three-dimensional shape of an object including a first portion and a second portion, the shape data including information on a first position of the first portion and a second position of the second portion;
acquiring a first measurement information data including a line segment data related to a line segment connecting the first position with the second position, the line segment corresponding to a length subjected to measurement; and
calculating a viewpoint based on the shape data and the first measurement information data,
a first image of the object as viewed from the viewpoint being generated from the shape data and the line segment data, the first image including an image of a first region of the object and an image of the line segment, the first region including the first position and the second position.

13. The method according to claim 12, wherein:
a plurality of candidate viewpoints serving as candidates of the viewpoint is calculated based on the shape data and the first measurement information data,
an evaluation shape data is generated based on the first measurement information data,
a plurality of viewpoint evaluation values is calculated based on the shape data and the evaluation shape data, the viewpoint evaluation values being related to the candidate viewpoints and corresponding to relative positional relationship between the shape data and the line segment data; and
the viewpoint is calculated from the candidate viewpoints based on the viewpoint evaluation values.

14. The method according to claim 13, wherein:
a coordinate axis is calculated based on the shape data and the first measurement information data, and
the coordinate axis serves as a reference for calculating the candidate viewpoints.

15. The method according to claim 13, wherein
the evaluation shape data includes information on at least part of a first sphere with a center at the first position, a second sphere with a center at the second position, and a cylinder with an axis on the line segment.

16. The method according to claim 15, wherein
the evaluation shape data further includes information of part of the shape data, and
the part of the shape data is extracted based on a vector, the vector passing through an intersection point of the line segment and a surface of the object based on the shape data, the vector being perpendicular to the surface of the object based on the shape data.

17. The method according to claim 12, further comprising:
displaying the first image rendering at least part of the shape data, and the first measurement information data.

18. The method according to claim 13, further comprising:
displaying the first image rendering at least part of the shape data, and the first measurement information data.

19. The method according to claim 12, further comprising:
acquiring a select signal,
wherein the acquiring the first measurement information data is based on the select signal.

20. The method according to claim 12, further comprising:
acquiring a select signal; and
integrating a second measurement information data and the first measurement information data based on the select signal, the object further including a third portion and a fourth portion, the second measurement information data being related to a line segment connecting a third position of the third portion with a fourth position of the fourth portion.
